(19) United States
(12) Patent Application Publication
(10) Pub. No.: US 2006/0129824 A1
(43) Pub. Date: Jun. 15, 2006

(54) Systems, methods, and media for accessing TPM keys

(76) Inventors: James Patrick Hoff, Raleigh, NC (US); David Rivera, Durham, NC (US)

Correspondence Address: LENOVO (SINAPORE) PTE. LTD. (RTP);c/o SCHUBERT OSTERRIEDER & NICKELSON PLLC, 6013 CANNON MTN. DR., S14, AUSTIN, TX, 78749, US

(21) Appl. No.: 11/012,836

(22) Filed: Dec. 15, 2004

(51) Int. Cl. H04L 9/00; G06F 12/14; H04L 9/32; G06F 11/30; H04K 1/00

(52) U.S. Cl. 713/176; 713/181; 713/193; 713/183

(57) ABSTRACT

Systems, methods and media for accessing and protecting TPM keys for signing and for decryption are disclosed. More particularly, hardware and software are disclosed for enabling a user knowing a signing-only authentication to access a key for signing only, upon submission of the signing only-authentication, and for enabling the user or a system administrator knowing a decryption-only authentication to access a key for decryption only, upon submission of the decryption-only authentication.

### FIELD

The present invention is in the field of encryption and digital signatures. More particularly, the invention is in the field of accessing and protecting keys for digital signing and decryption.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, accounting, e-mail, voice over Internet protocol telecommunications, and facsimile.

With the advent of the internet and wide spread use of computers, more and more commercial transactions occur electronically. To facilitate this “e-commerce,” computing networks employ encryption and digital signatures. Encryption enables a user to conceal messages transmitted over a network. Decryption enables recovery of the original message from its encrypted counterpart. Digital signatures enable the user to sign documents electronically. Forming a digital signature involves encryption in a public key cryptography system. The system employs an algorithm using two different but mathematically related “keys;” one for creating a digital signature and another for verifying a digital signature. Computer equipment and software utilizing two such keys are often collectively termed an “asymmetric cryptosystem.”

The complementary keys of an asymmetric cryptosystem for digital signatures are termed the private key and the public key. The signer uses the private key to create the digital signature. Ideally, only the signer can access his private key. The public key is ordinarily more widely known. A party to rely on the signature uses the public key to verify the digital signature. Although the keys of the pair are mathematically related, it is computationally infeasible to derive the private key from the public key. Thus, although many people may know the public key of a given signer and use it to verify that signer's signature, they cannot access the signer's private key to forge the signer's digital signature. This is the principle of “irreversibility.”

A fundamental process to create and verify digital signatures is a “hash function.” A hash function is an algorithm that creates a digital representation or “fingerprint” in the form of a “hash result.” The hash result is usually much smaller than the message but is, nevertheless, substantially unique to it. This hash result is encrypted using the signer's private key to create the digital signature. Any change to the message invariably produces a different hash result when the same hash function is used. For a secure hash function, it is computationally infeasible to derive the original message from its hash value. Hash functions therefore enable the software for creating digital signatures to operate on smaller and predictable amounts of data, while still providing robust evidentiary correlation to the original message content.

To sign a document or any other item of information, the signer first delimits precisely the borders of what is to be signed. The delimited information to be signed is termed the “message.” Then a hash function in the signer's software computes a hash result unique (for all practical purposes) to the message. The signer's software then encrypts the hash result into a digital signature using the signer's private key. The resulting digital signature is thus unique to both the message and the private key used to create it.

When a signer sends a signed message, the unsigned message is also sent. The recipient verifies the signature by using the user's public key to decrypt the encrypted hash. The recipient also hashes the unsigned message. The two hash results are then compared. The signature is verified only if the two hash results are the same. The equality of the hash results means that the message signed by the sender is the one received by the recipient. Then, the sender cannot repudiate that he signed the message received and verified by the recipient. The verifier of a digital signature must have assurance that the signature was made by a particular person. This assurance arises from a trusted third party that issues a certificate that certifies that signatures that can be verified using the public key specified in the certificate belong to the party identified in the certificate.

Again, the holder of a private key must not lose control of it. Use of the private key is typically protected by a password known only by the holder of the private key. Unauthorized use of the user's private key to digitally sign electronic documents is forgery. Because of the great harm that electronic forgery can inflict on the user and third parties, not even a system administrator who ordinarily has control over passwords should have access to a user's private key password. However, the system administrator needs access to the user's decryption key for decryption of material of the user. This may be required, for example, when an employee leaves his or her employer. Thus, a user needs a private key for digital signing and another key for decryption. However, a system administrator should have access only to the decryption key.

The Trusted Computing Group (TCG), a standards-setting entity, has defined and published a specification to enable trust and security capabilities on computing platforms in general. They define a trusted subsystem that can be integrated into every computing platform in order to build a secure computing base. The functions defined by the TCG are integrated into a Trusted Platform Module (TPM). The TPM comprises a CPU and memory to securely perform functions relating to security and privacy.

The Trusted Computing Group (TCG) specification for a TPM defines separate keys for signing and decryption. However, a Public Key Infrastructure (PKI) typically requires the same key to be used for signing and decryption. The TPM also supports legacy keys. A legacy key may be used for both signing and decryption. But a problem with using a legacy key is that the same authentication is used for both signing and decryption. Thus, access to the key for decryption also gives access to the key for digital signing. This would violate the non-repudiation requirement that the system administrator cannot have access to the user's private key for signing.

Thus, there is a need to provide access to a user's decryption key material without giving access to the user's private key for digitally signing documents.

### SUMMARY

The problems identified above are in large part addressed by systems, methods and media for assuring non-repudiation with Trusted Platform Module (TPM) keys. According to an aspect of the present invention, the authentication for using a key to digitally sign an electronic message is separate from the authentication for using the same key to decrypt an electronic message. In one embodiment, two separate authentications are provided for the same legacy key. In another embodiment the TPM encrypts a user private key and associates the key with one authentication for signing and with another authentication for decryption.

Thus, one embodiment provides a process for enabling use of a legacy key to digitally sign an electronic message upon receipt of a first authentication and verification that the received first authentication is a correct authentication for signing. The process also includes enabling use of the legacy key to decrypt an encrypted electronic message upon receipt of a second authentication different from the first authentication and verification that the received second authentication is a correct authentication for decrypting.

Another embodiment provides a first set of key material comprising a user private key, a first authentication, and a signing-only authority. Knowledge of the first authentication enables use of the key only to digitally sign a message on a Trusted Platform Module. The embodiment also provides a second set of key material comprising the user private key (equivalent to the user private key used for signing), a second authentication, and a decryption-only authority. Knowledge of the second authentication enables use of the key only to decrypt a message on the Trusted Platform Module.

Embodiments include a Trusted Platform Module to encrypt a user private key, a first authentication and a second authentication, and to decrypt the user private key. An embodiment also includes a memory to store the encrypted user private key and encrypted authentication. In this embodiment, the first authentication is associated with an authority for signing and the second authentication is associated with an authority for decryption. The memory may further store an encrypted table of authentications. A random value generator may generate the authentications for the table.

Embodiments include machine accessible media containing instructions effective, when executing in a data processing system, to cause the data processing system to perform operations that include providing a first set of key material comprising a user private key, a first authentication, and a signing-only authority. The first authentication enables use of the key only to digitally sign a message on a Trusted Platform Module. The operations further include providing a second set of key material comprising the user private key, a second authentication, and a decryption-only authority. The second authentication enables use of the key only to decrypt a message on the Trusted Platform Module.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a computer system within a network; within the computer system is a method of separating authentications for keys.

FIG. 2A depicts a first embodiment for separate signing and decryption authentications.

FIG. 2B depicts a second embodiment for separate signing and decryption authentications.

FIG. 3 depicts an embodiment of a Trusted Platform Module.

FIG. 4A depicts a flow chart for creating a key that has separate authentications and different authorizations.

FIG. 4B depicts a flow chart of authentication for signing or decryption.

FIG. 5 depicts a table of encrypted authentications.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Embodiments of the invention include systems for enabling an authorized third party such as a system administrator to gain access to a user's encrypted material without gaining access to the user's private key for digitally signing documents. More generally, embodiments provide separate authorizations for signing and decrypting electronic messages. One embodiment provides separate authentications for signing and decrypting using a legacy key. Another embodiment provides separate authentications for the same user private key. Ideally, only the person authorized to hold the key for signing knows the authentication for signing. In contrast, the user knows the authentication for decryption, but a system administrator may be able to change this authentication. However, embodiments do not archive the authentication for signing and the system administrator does not know it. Only the encrypted authentication is archived. Therefore, the system administrator may not electronically forge the user's signature.

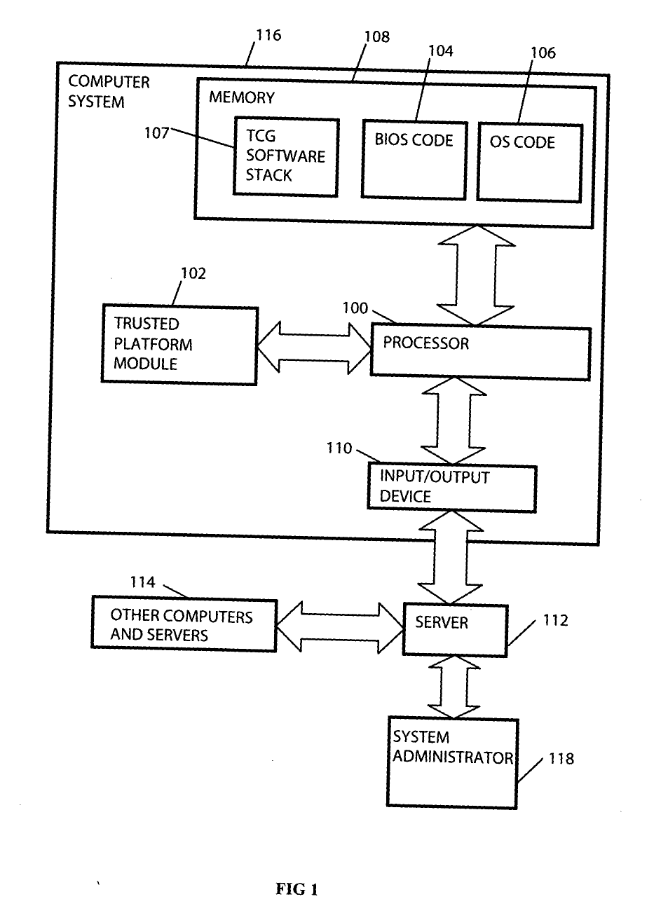

FIG. 1 shows a computer system 116 implemented according to an embodiment of the present invention. Computer system 116 comprises a processor 100 operating in conjunction with a Trusted Platform Module (TPM) 102. Processor 100 operates according to BIOS Code 104 and Operating System (OS) Code 106. The BIOS and OS code is stored in memory 108. The BIOS code is typically stored on Read-Only Memory (ROM) and the OS code is typically stored on the hard drive of computer system 116. Computer system 116 also includes a Trusted Computing Group Software Stack (TSS) 107. TSS 107 comprises executable instructions to TPM 102 to implement embodiments for separate authentications for signing and decryption.

Computer system 116 also typically includes other components and subsystems not shown, such as: memory controllers, random access memory (RAM), peripheral drivers, a system monitor, a keyboard, one or more flexible diskette drives, one or more removable non-volatile media drives such as a fixed disk hard drive, CD and t)VD drives, a pointing device such as a mouse, and an network interface adapter, etc. Computer systems 116 may include personal computers, workstations, servers, mainframe computers, notebook or laptop computers, desktop computers, or the like.

Processor 100 communicates with TPM 102 to transfer data and commands. Processor 100 may also communicate with a server 112 by way of Input/Output Device 110. Server 112 connects computer system 116 with other computers and servers 114. Thus, computer system 116 is in a network of computers such as the Internet and/or a local Intranet. As shown in FIG. 1, a system administrator 118 may communicate with computer system 116 through server 112. The system administrator 118 may be able to set the authentication for the user's key(s) for decryption but the system administrator cannot set the authentication for the user's key(s) for signing.

The TPM 102 is a microcontroller that protects cryptographic keys. This yields enhanced security of passwords and digital certificates. TPM 102 typically affixes to the motherboard of a PC, but incorporates into any system where security is required. The main chip of TPM 102 contains a special security controller with some internal, non-volatile ROM for the firmware, and non-volatile EEPROM for the data and RAM. Furthermore, it contains a cryptographic engine for performing encryption and decryption, and a hash function for hashing, and a random number generator to generate secure cryptographic keys.

The TPM 102 offers protected storage, platform authentication, protected cryptographic processes and attestable state capabilities to provide the first level of trust for the computing platform. The foundation of this trust is the certification by a recognized authority that TPM 102 can be trusted for an intended purpose. The Trusted Computing Group (TCG), a standards-setting entity, has defined and published a specification to enable trust and security capabilities on computing platforms in general. They define a trusted subsystem that can be integrated into every computing platform in order to build a secure computing base. The functions defined by the TCG are integrated into the TPM 102, which can be compared to an integrated smart card containing a CPU, some memory and special applications.

TPM 102 provides for separate keys for signing and decrypting. TPM 102 also provides legacy keys. As noted above, a legacy key is used for both signing and decrypting. In some embodiments, separate authentications are implemented for signing and for decrypting with a legacy key. Processor 100 executes software that enables the user to enter a password when the user desires to digitally sign a document. Only the correct password, ideally known only to the user, will make the private key available for signing. Processor 100 also executes software that enables the user to enter a password when the user desires to decrypt data. Only the correct password, ideally known only to the user and authorized third persons, will make the key available for decryption.

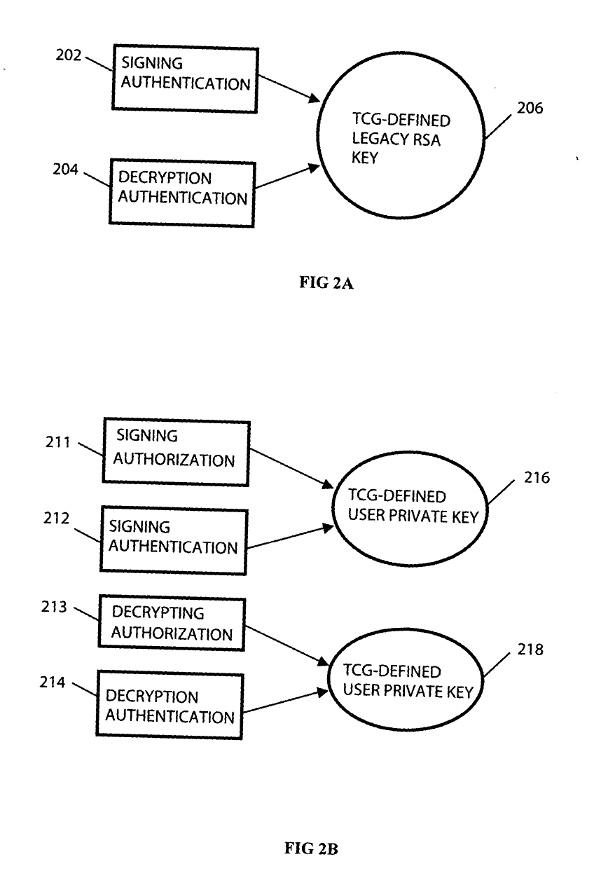

Therefore, one embodiment provides separate authentications for a legacy key. This is illustrated graphically in FIG. 2A. A signing authentication (element 202) is separate from a decryption authentication (element 204.) Signing authentication (element 202) authorizes signing with a TCG-defined legacy RSA key (element 206.) Decryption authentication (element 204) authorizes decrypting with the TCG-defined legacy RSA key (element 206.)

To provide separate authentication for a legacy key as shown in FIG. 2A requires modification of the TPM_ASYMKEY data structure. The data structure currently defined is:

```
typedef struct tdTCPA_STORE_ASYMKEY {
    TCPA_PAYLOAD_TYPE payload;
    TCPA_SECRET usageAuth;
    TCPA_SECRET migrationAuth;
    TCPA_DIGEST pubDataDigest;
    TCPA_STORE_PRIVKEY privkey;
} TCPA_STORE_ASYMKEY;
```

The new data structure implemented in an embodiment is:

```
typedef struct tdTCPA_STORE2_ASYMKEY {
    TCPA_PAYLOAD_TYPE payload;
    TCPA_SECRET bindUsageAuth;
    TCPA_SECRET signUsageAuth;
    TCPA_SECRET migrationAuth;
    TCPA_DIGEST pubDataDigest;
    TCPA_STORE_PRIVKEY privkey;
} TCPA_STORE_ASYMKEY;
```

Note the use of two usage authentications, “bindUsageAuth” and “signUsageAuth”, in the new data structure as opposed to the single usage authentication provided by the prior data structure. The key is designated as a 2-authentication key in the TPM_KEY_PARMS structure so the TPM knows to use the new data structure. When TPM_SIGN is called to sign a digital message, the TPM uses the signUsageAuth authentication. Ideally, only the person who has the right to use the key for signing knows the signing authentication. When TPM_BIND is called to decrypt an encrypted digital message, the TPM uses the bindUsageAuth authentication. Ideally, only the persons who have the right to use the key for decrypting know the decrypting authorization.

As noted, ideally, only the correct user knows the signing authentication. The authentication for signing with the private key is not archived and is not accessible to the system administrator, so that only the true owner of the key can attest to his identity with that private key. The user also knows the authentication for decryption, but the system administrator can change this. Thus, the system administrator can access and decrypt a user's encrypted information and the system administrator can deprive a user of access to the private key for decryption. But the system administrator does not know the authentication for access to the key for signing. Thus, the system administrator cannot electronically forge the user's signature, thereby meeting the requirement of non-repudiation.

In a Public Key Infrastructure (PKI) environment, a user digitally signs a message by using the user's private key to encrypt a hash of the message. That is, a message is “signed” by hashing it and then encrypting it with a user's private key. The user transmits the signed message along with the unencrypted message and the user's public key. When received, the receiver uses the public key to decrypt the signed message to obtain a first hash value. The receiver also hashes the received unencrypted message to obtain a second hash value. If and only if the two hash values are the same is the content of the received signed message the same as the content of the received unsigned message. Thus, if the received unsigned message is altered from the original signed message, the two hash values will be different and verification that the message is what the user signed fails. Also, in the PKI environment, a sender of a message to the user may encrypt the message using the user's public key. Because of the asymmetry of the public-private key system, only the user's private key can be used to decrypt the message that was encrypted with the user's public key. The sender and the user are thus assured that the sent message can only be read by the user. Thus, in PKI communications the same key is used to sign and decrypt.

In a secure system, signing and decryption using a user's private key takes place in the TPM. Thus, the embodiments of the invention described herein contemplate that encryption (signing) and decryption take place in the TPM. The user private key never leaves the TPM and is therefore secret. An encrypted key can be stored outside the TPM. However, the TPM decrypts the encrypted key wholly within the TPM and the decrypted key does not leave the TPM. The TPM uses the decrypted key within the TPM to encrypt a hash of a message when signing the message or it uses the decrypted key within the TPM to decrypt information encrypted with the user's public key.

The method separates the authorized uses of the key by providing separate authentications for each use. Thus, one embodiment provides separate authentications for signing and decryption for the same legacy key. Another embodiment of the invention also provides separate authentications for a key. This is illustrated graphically in FIG. 2B. The embodiment provides a signing authorization (element 211) and a signing authentication (element 212) to authorize only signing with a TCG-defined user private key (element 216.) The embodiment also provides a decryption authorization (element 213) and a separate decryption authentication (element 214) to authorize only decryption with the TCG-defined key (element 218.) Note that if the keys for signing and for decryption were different a user could not decrypt material encrypted with the public key corresponding to the private key for signing. This would be an obstacle to secure PKI-based communications, because in the PKI system the key for signing an outgoing message is the same as the key for decrypting an incoming message encrypted by a sender with the user's public key. Therefore, an embodiment provides separate authentications for signing and decrypting with the same key.

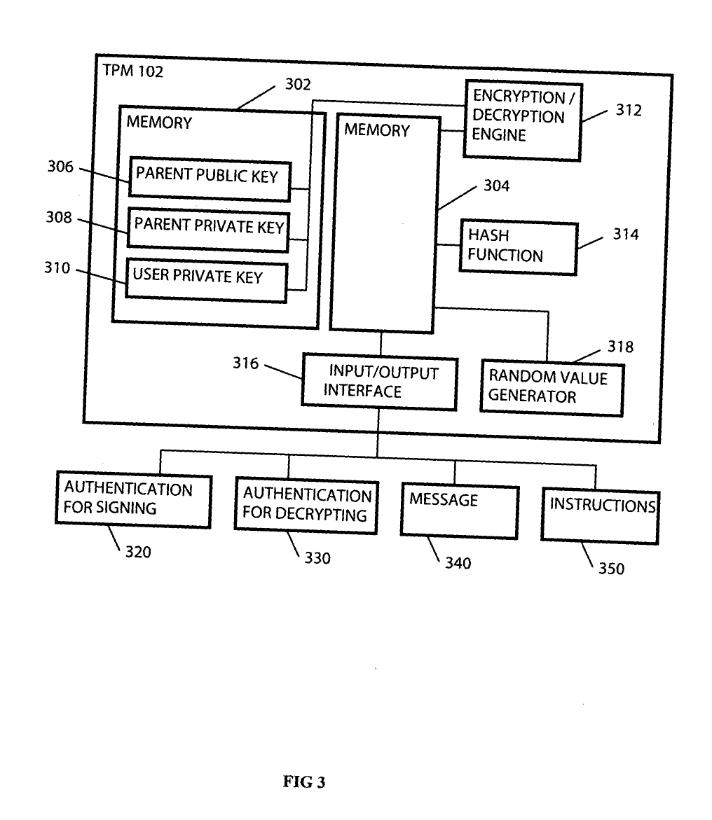

Thus, in one embodiment, TPM 102 creates and subsequently uses keys for signing and decryption with separate authentications, and separate authorizations, but using the same user private key. FIG. 3 illustrates a functional block diagram of an embodiment of TPM 102. TPM 102 operates according to instructions 350 received from the TCG Software Stack, TSS 107. In a memory 302 of TPM 102 is a parent key with a public component 306 and a private component 308. Also within memory 302 of TPM 102 are one or more user private keys 310. The TPM uses the public component of the parent key to form two different keys from the same user private key. The TPM software defines keys by a set that includes the user private key, an authentication, and an authority. The TPM software defines a signing-only key by a set comprising the user private key, an authentication for signing, and an authority for signing. The TPM software defines a decryption-only key by a set comprising the user private key, an authentication for decryption, and an authority for decryption but not for signing. The keys defined this way can be used for PKI communications. Ideally, only the user knows the authentication for signing, whereas the user or a system administrator knows the authentication for decryption.

TPM 102 also comprises an encryption/decryption engine 312 and a hash function 314. To sign a message 340 digitally, the message is received into a memory 304 through input/output interface 316. Note that memory 304 is physically separate from memory 302. Memory 302, which stores keys, is in a separate programmable Read-Only Memory (ROM). Memory 304, which provides transitory storage, is implemented in Random Access Memory (RAM). A device external to the TPM cannot access memory 302 and thus cannot access the parent keys or the user keys. Hash function 314 hashes the message received into memory 304. Then, encryption engine 312 encrypts the hash with user private key 310. The encrypted hash is the digitally signed message and can be stored in memory 304 and transmitted out of TPM 102 through input/output interface 316. Also, an encrypted message may be received into memory 304 and decrypted by decryption engine 312. Further, to verify a digital signature, decryption engine 312 decrypts the signature to produce a first hash. Hash function 314 hashes the unhashed message received with the digital signature to produce a second hash. TPM 102 then compares the two hashes. If they are the same, the signature is verified.

Second memory 304 receives authentications for signing and for decryption. To create a signing authentication process, TPM 102 receives into memory 304 an authentication for signing 320. Alternatively, a random value generator 318 can generate a random authentication received by memory 304. To create a key for digitally signing a message, encryption engine 312 encrypts the received authentication for signing using the parent public key. The encrypted authentication for signing can be stored on TPM 102 and can be stored outside TPM 102. During a signing authentication process, memory 304 receives an authentication for signing. Decryption engine 312 decrypts the previously stored authentication for signing using the parent public key and compares it to the received authentication for signing. If the received authentication is the same as the previously stored authentication, TPM 102 decrypts the encrypted user private key using the parent private key, allowing the user private key to be used for signing a message.

Similarly, to create a decryption authentication process for authenticating for decryption, TPM 102 receives into memory 304 an authentication for decryption 330. Alternatively, random value generator 318 can generate a random authentication received by memory 304. To create a key for decryption, encryption engine 312 encrypts the received authentication for decryption using the parent public key. The encrypted authentication for decryption can be stored on TPM 102 and can be stored outside TPM 102. During a decryption authentication process, memory 304 receives an authentication for decrypting. Decryption engine 312 decrypts the previously stored authentication for decrypting using the parent public key and compares it to the received authentication for decryption. If the received authentication is the same as the previously stored authentication, TPM 102 decrypts the encrypted user private key using the parent private key. TPM 102 then allows the user private key to be used for decrypting a message but not for signing a message.

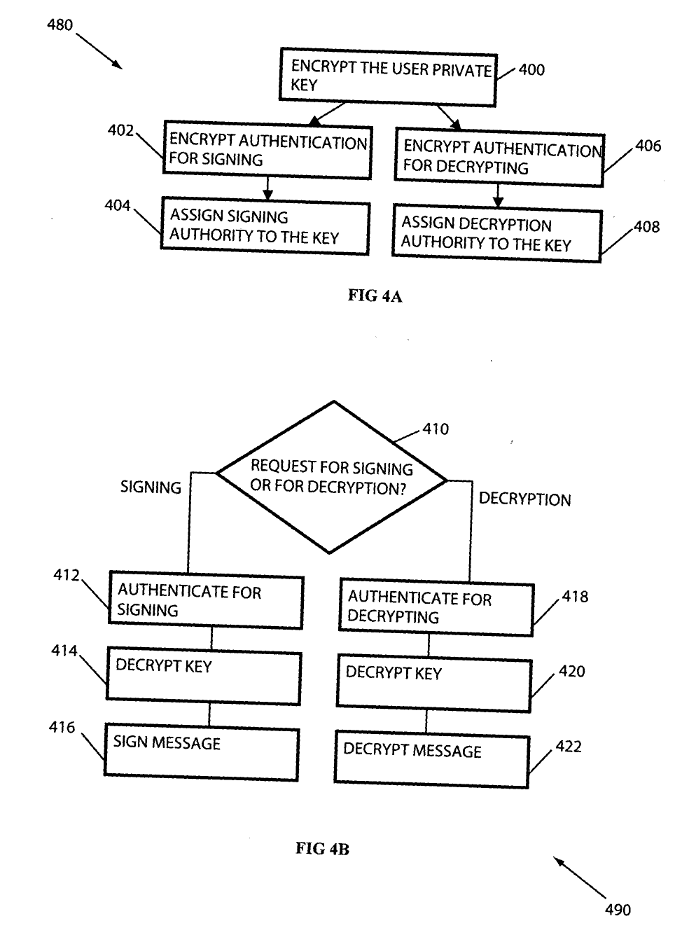

FIG. 4A shows a flow chart 480 of the operation of an embodiment of TPM 102 to create a key for signing and a key for decrypting using the same user private key. To create the keys for signing and decryption TPM 102 uses the parent public key in TPM 102 to encrypt a user private key in an encryption engine (element 400.) The encrypted user private key is used to create a key for signing and a key for decrypting. To create the key for signing, TPM 102 receives into memory an authentication for signing and encrypts it in the encryption engine (element 402.) TPM 102 then assigns an authority for signing (element 404) to the key. To create the key for decrypting, TPM 102 receives into memory an authentication for decrypting and encrypts it in the encryption engine (element 406.) TPM 102 then assigns an authority for decrypting (element 408) to the key.

Thus, in one embodiment a first set of key material for signing comprises the encrypted user private key, an encrypted authentication for signing, and a code to indicate that the authority for the key is for signing. A second set of key material for decrypting comprises the encrypted user private key, an encrypted authentication for decrypting, and a code to indicate that the authority for the key is for decrypting. Thus, two distinct keys are formed using the same user private key, but with separate authentications and different authorizations.

FIG. 4B shows a flow chart 490 of the operation of an embodiment of TPM 102 to sign or decrypt a message using the keys created as shown in FIG. 4A. When TPM 102 receives a request for signing or for decryption (element 410), TPM 102 receives an authentication for signing or for decrypting. TPM 102 also receives the message to be signed or decrypted. When the request is for signing, TPM 102 determines if the received authentication for signing is correct (element 412.) To do this, TPM 102 decrypts the encrypted signing authentication created when the key was created with the parent key, and compares it to the received authentication. If the received authentication for signing is correct, TPM 102 uses the parent private key 308 to decrypt the user private key (element 414) in the decryption engine. TPM 102 then signs the message (element 416) by using the hash function to hash the message and then using the user private key 310 to encrypt the hash in encryption engine 312.

When the request is for decrypting, TPM 102 determines if the received authentication for decrypting is correct (element 418.) To do this, TPM 102 decrypts the encrypted decryption authentication created when the key was created with the parent key, and compares it to the received authentication. If the received authentication for decryption is correct, TPM 102 uses the parent private key to decrypt the user private key (element 420) in the decryption engine. TPM 102 then decrypts the message (element 422) with the user private key in the decryption engine.

Thus, when a user requests to sign a message, TPM 102 uses the private component of the parent key to authenticate the authority of the user to use the key for signing. More specifically, the user may enter a signing authorization password known only to the user. The user-entered password is provided to the TPM 102 and compared to the decrypted password that was employed to create the signing-only key. Upon proper authentication, TPM 102 uses the private component of the parent key to decrypt the user private key within TPM 102. TPM 102 then uses the user private key to sign the message.

When a user requests to decrypt a message, TPM 102 uses the private component of the parent key to authenticate the authority of the user to use the key for decryption. More specifically, the user may enter a decryption authorization password known only to the user and to the system administrator. The user-entered decryption authorization password is provided to the TPM 102 and compared to the decrypted password that was employed to create the decryption-only key. Upon proper authentication, TPM 102 uses the private component of the parent key to decrypt the user private key within TPM 102. TPM 102 then uses the user private key to decrypt the message. Thus, the key for decrypting is the same as the key for signing, but the authentications are separate and the authorizations are different.

The embodiments described above employ separate authentications to access a key for signing and for decryption. The system does not archive the authentication for signing which ideally only the user knows. The system may archive the authentication for decryption, which may be accessible by the system administrator. Note that the parent and user keys never leave TPM 102. That is, they are never “out in the open.” Thus, the system administrator can use the key for decryption but cannot otherwise use and cannot access the user private key. The user private key is kept secret on TPM 102.

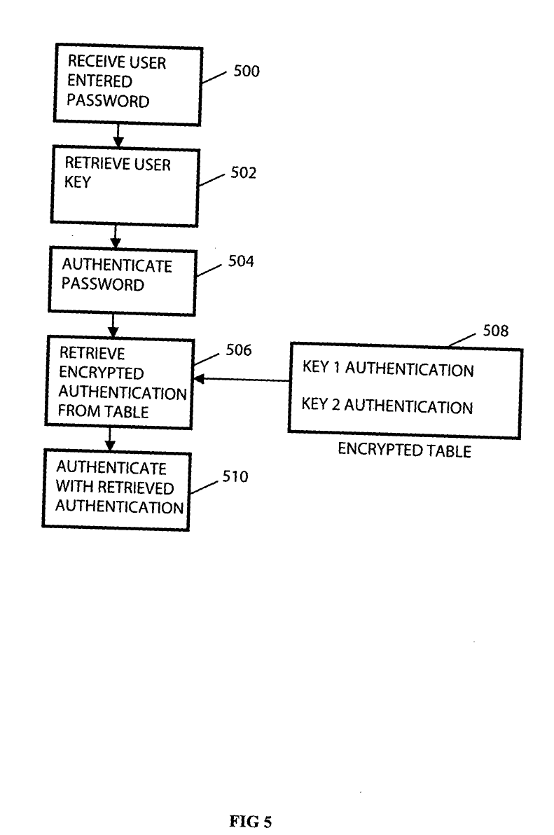

Users may use multiple keys for different purposes. For example, a user may use different certificates for different e-mail addresses or for encryption of different categories of files, or for Secure Socket Layer (SSL) authentication, etc. The problem arises how to access and use these keys without having to remember the authentication for each of them. One solution is to use a table as shown in FIG. 5. A table 508 comprises a plurality of randomly generated usage authentications, one for each key. Table 508 is an encrypted table so that the actual authentications are not out in the open. Only the encrypted table entries are outside the TPM. When the user enters a master password (element 500), the TPM accesses a user key (element 502) and uses it to encrypt the user-entered master password. The user-entered master password is authenticated (element 504) by passing it to the TPM and comparing it to the value decrypted by the TPM. If the master password is authenticated, then a value in the table can be retrieved (element 506) from table 508 and used to authenticate use of a key (element 510.) The TPM 102 compares the value from the table to an encrypted value of the authentication stored in memory. Upon proper authentication, the system may use the key for its authorized purpose, either signing or decrypting.

To store multiple key authentications, some used for signing and some used for decrypting, the system can store one encrypted table for decryption-only authentications and the system can store another encrypted table for signing-only authentications. A first authentication is required to access the table of signing authentications and a second authentication is required to access the table of decryption-only authentications. A random value generator 318 can randomly generate the authentication entries of each table. Ideally, only the user knows the authentication for decrypting the table of signing-only authentications. The user and possibly the system administrator know the authentication for decrypting the table of decryption-only authentications.

In the alternative to storing separate signing authentications in a table, one embodiment provides a separate user-chosen signing authentication for each different key for signing. But this embodiment would require the user to remember multiple passwords for multiple signing keys. In another embodiment, each legacy key can use the same signing authentication. When the system generates the key, the system prompts the user for a signing-only password for that key. The user may use the same password for each key. Thus, several signing keys can have the same password.

In general, a computer program stored on a machine accessible medium may be provided to implement the methods of the present invention. The computer program of the present invention typically is comprised of a multitude of instructions translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature used herein is used merely for convenience, and thus the invention should not be limited to use solely in any specific application identified and/or implied by such nomenclature.

A machine accessible medium may comprise random access memory, read-only memory, a hard drive, a floppy disk, a diskette, a compact CD or DVD, or other media. An embodiment of the invention provides a machine-accessible medium containing instructions effective, when executing in a data processing system, to cause the system to perform a series of operations for providing separate authentications for signing and decrypting with a key. The operations include providing a first authentication process to use a legacy key for digitally signing a message on a Trusted Platform Module. The first authentication process requires knowledge of a first password to use the key for signing. The operations further include providing a second authentication process to use the legacy key for decrypting a message. The second authentication process requires knowledge of a second password to use the key for decrypting.

Another embodiment of the invention provides a machine-accessible medium containing instructions effective, when executing in a data processing system, to cause the system to perform a series of operations for providing separate authentications for signing and decryption. The operations include providing a first set of key material comprising an encrypted user private key, an encrypted first authentication, and a signing-only authority. Knowledge of the first authentication enables use of the key to digitally sign a message on a Trusted Platform Module. The operations further include providing a second set of key material comprising the encrypted user private key, an encrypted second authentication, and a decryption-only authority. Knowledge of the second authentication enables use of the user private key to decrypt a message on the Trusted Platform Module but does not enable use of the key to sign a message. Another embodiment of the invention provides a machine-accessible medium containing instructions effective, when executing in a data processing system, to cause said data processing system to perform operations comprising requiring a first authentication to use a legacy key for signing a message in response to a request for signing; and requiring a second authentication to use the legacy key for decrypting a message in response to a request for decrypting.

Although the present invention and its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims include within their scope such processes, machines, manufacture, compositions of matter, means, methods, or steps.

What is claimed is:

1. A method for allowing access to keys for signing and decrypting electronic messages, comprising:
enabling use of a legacy key to digitally sign an electronic message upon receipt of a first authentication and verification that the received first authentication is a correct authentication for signing; and
enabling use of the legacy key to decrypt an encrypted electronic message upon receipt of a second authentication different from the first authentication and verification that the received second authentication is a correct authentication for decrypting.

2. The method of claim 1, further comprising computing a hash of a message to be signed and encrypting the hash with the user private key on a Trusted Platform Module.

3. The method of claim 1, further comprising computing a first hash of the message and comparing the first hash to a second hash determined via decryption of the message, wherein the message is a signed message.

4. The method of claim 1, further comprising encrypting the first and second authentications with a public component of a parent key on a Trusted Platform Module.

5. The method of claim 1, wherein receiving the user authentication comprises prompting a user for the user authentication in response to receipt of a request.

6. The method of claim 1, wherein decrypting the key to sign the message comprises obtaining the first authentication from an encrypted table of authentications to verify that the user authentication is the first authentication.

7. The method of claim 6, wherein decrypting the key to sign the message comprises verifying that the user authentication received from the user is the first authentication, wherein the request comprises a request to sign the message.

8. The method of claim 6, wherein decrypting the key to decrypt the message comprises verifying that the user authentication received from the user is the second authentication, wherein the request comprises a request to decrypt the message.

9. A method for allowing access to keys for signing and decrypting messages, comprising
encrypting a user private key, a first authentication, and a second authentication on a Trusted Platform Module;
comparing a user authentication with at least one of the first and second authentications upon receipt of the user authentication;
decrypting the user private key and digitally signing a message if the user authentication matches the first authentication; and
decrypting the user private key and decrypting a message if the user authentication matches the second authentication.

10. The method of claim 9, further comprising generating a random value to create the first authentication.

11. The method of claim 9, further comprising encrypting the user private key and the first and second authentications with a public component of a parent key on the Trusted Platform Module.

12. The method of claim 9, further comprising decrypting the user private key with a private component of a parent key on the Trusted Platform Module.

13. The method of claim 9, wherein comparing the user authentication comprises obtaining the first authentication from a table comprising at least the first and second authentications.

14. An apparatus for allowing access to keys for decrypting and for signing electronic messages, comprising:
an encryption mechanism to encrypt a user private key to produce an encrypted user private key, a first authentication for digitally signing the messages to produce an encrypted first authentication, and a second authentication for decrypting the messages to produce an encrypted second authentication, wherein the first authentication and the second authentication are different;
a memory coupled with the encryption mechanism to store the encrypted user private key, the encrypted first authentication and the encrypted second authentication;
a decryption mechanism coupled with the memory to decrypt the encrypted user private key;
a signing authentication module coupled with the decryption mechanism to enable use of the user private key to sign one or more of the messages upon receipt of the encrypted first authentication; and
a decrypting authentication module to enable use of the user private key to decrypt one or more of the messages upon receipt of the encrypted second authentication.

15. The apparatus of claim 14, further comprising a random value generator for generating the first authentication.

16. The apparatus of claim 14, further comprising memory to store an encrypted table of authentications associated with signing.

17. The apparatus of claim 14, further comprising a hash module adapted to hash the messages for signing or verifying the signing of the messages.

18. The apparatus of claim 17, wherein the encryption mechanism is adapted to encrypt the hash with the user private key.

19. The apparatus of claim 14, wherein the signing authentication module is adapted to compare an encrypted authentication with the encrypted first authentication upon receipt of the encrypted authentication.

20. The apparatus of claim 14, wherein the decrypting authentication module is adapted to compare an encrypted authentication with the encrypted second authentication upon receipt of the encrypted authentication.

21. A machine-accessible medium containing instructions effective, when executing in a data processing system, to cause said data processing system to perform operations comprising:
encrypting a user private key, a first authentication, and a second authentication on a Trusted Platform Module;
comparing a user authentication with at least one of the authentications upon receipt of the user authentication, wherein the user authentication is associated with a message;
decrypting the user private key and digitally signing the message if the user authentication matches the first authentication; and
decrypting the user private key and decrypting the message if the user authentication matches the second authentication.

22. The machine accessible medium of claim 21, wherein the operations further comprise obtaining the first authentication from an encrypted set of authentications stored in a memory.

23. The machine accessible medium of claim 21, wherein the operations further comprise generating a random value to generate the second authentication.

24. A machine-accessible medium containing instructions effective, when executing in a data processing system, to cause said data processing system to perform operations comprising:
receiving a user authentication associated with a message;
decrypting a key to sign the message upon receipt of a first authentication; and
decrypting the key to decrypt the message upon receipt of a second authentication, wherein the second authentication is different from the first authentication.

25. The machine-accessible medium of claim 24, wherein receiving the user authentication comprises prompting the user for the user authentication.

26. The machine-accessible medium of claim 24, wherein decrypting the key to decrypt comprises accessing a table of authentications to obtain the second authentication.
